(19) United States
(12) Patent Application Publication
(10) Pub. No.: US 2016/0170566 A1
(43) Pub. Date: Jun. 16, 2016

(54) METHOD AND SYSTEM FOR POINTING TO AND VOTING ON SPECIFIC DETAILS FOUND IN VISUAL MEDIA

(71) Applicant: Askem Tlv Ltd, Tel Aviv (IL)

(72) Inventors: Itai Herman, Tel Aviv (IL); Jonathan Hemi, New York, NY (US); Tomer Zakai, Tel Aviv (IL); Zeev Rubinstein, Tel Aviv (IL)

(73) Assignee: Askem Tlv Ltd, Tel Aviv (IL)

(21) Appl. No.: 14/222,765

(22) Filed: Mar. 24, 2014

Related U.S. Application Data
(60) Provisional application No. 61/804,669, filed on Mar. 24, 2013.

(51) Int. Cl. G06F 3/0481

(52) U.S. Cl. CPC G06F 3/0481

(57) ABSTRACT

A method of expression and interaction between users. The method includes posing a question and responding by voting, pointing at or choosing between specific options in media content. The content can include text, audio, photo(s), drawing(s), 3D images, motion pictures, holographic representations, cartoon illustration(s) and video elements.

### FIELD OF THE INVENTION

The present invention generally relates to interactive visual media technology, and more particularly to a method and system for pointing to and voting on specific details found in visual media.

### BACKGROUND OF THE INVENTION

Thought and speech bubbles for association with screen image characters, for example, are abundantly available on the Internet. In US Pat. App. No. 20120239459, Modeling a Plurality Of Contests at a Crowdsourcing Node, assigned to Microsoft, crowdsourcing is described, for example, where solutions to tasks such as designing a logo, writing a piece of code or answering a question are solicited by making open calls to large scale communities. In an example, a crowdsourcing node models a plurality of contests as all-pay auctions, each contest having a task and a reward.

However, the development of thought and speech bubbles for such usage has remained primitive. Thus, it would be advantageous to provide state-of-the-art characteristics for thought and speech bubbles for association with screen images.

### SUMMARY OF THE INVENTION

Accordingly, the present invention provides a method of expression and illustration based on digital media and user inputs, so that the user input can be textual or imagery. The image may be a fixed image such as a drawing, cartoon, photo or video/film. Alternatively the imagery may be streaming

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of a non-limiting example only, with reference to the accompanying drawings, in the drawings:

FIGS. 1 through 7 are screenshot illustrations of the pointing and voting tool, constructed according to an exemplary embodiment of the present invention:

FIG. 1 is a screenshot illustration of a floating pop-up, that can be placed on any screen, constructed according to the principles of the present invention;

FIG. 2 is a screenshot illustration of the ability to drag and move the floating pop-up of FIG. 1, constructed according to the principles of the present invention;

FIG. 3 is a screenshot illustration of the ability of the floating pop-up to point anywhere, constructed according to the principles of the present invention;

FIG. 4 is a screenshot illustration of the ability to write on the floating pop-up, constructed according to the principles of the present invention;

FIG. 5 is a screenshot illustration of the ability of the floating pop-up to adjust its size to the text length, constructed according to the principles of the present invention;

FIG. 6 is a screenshot illustration of the ability to differentiate among a plurality of on-screen floating pop-ups by means of colors, fill patterns and/or fonts, etc, constructed according to the principles of the present invention;

FIG. 7 is a screenshot illustration of the ability to differentiate among a plurality of on-screen floating “answer” pop-ups by displaying corresponding answers, constructed according to the principles of the present invention; and

FIG. 8 is a schematic illustration of the relationship between the popup producer and a plurality of consumers and general users, constructed according to the principles of the present invention.

All the above and other characteristics and advantages of the invention will be further understood through the following illustrative and non-limitative description of preferred embodiments thereof.

### DETAILED DESCRIPTION OF PREFERRED EMBODIMENTS

The principles and operation of a method and an apparatus according to the present invention may be better understood with reference to the drawings and the accompanying description, in which like numerals designate corresponding elements throughout, it being understood that these drawings are given for illustrative purposes only and are not meant to be limiting.

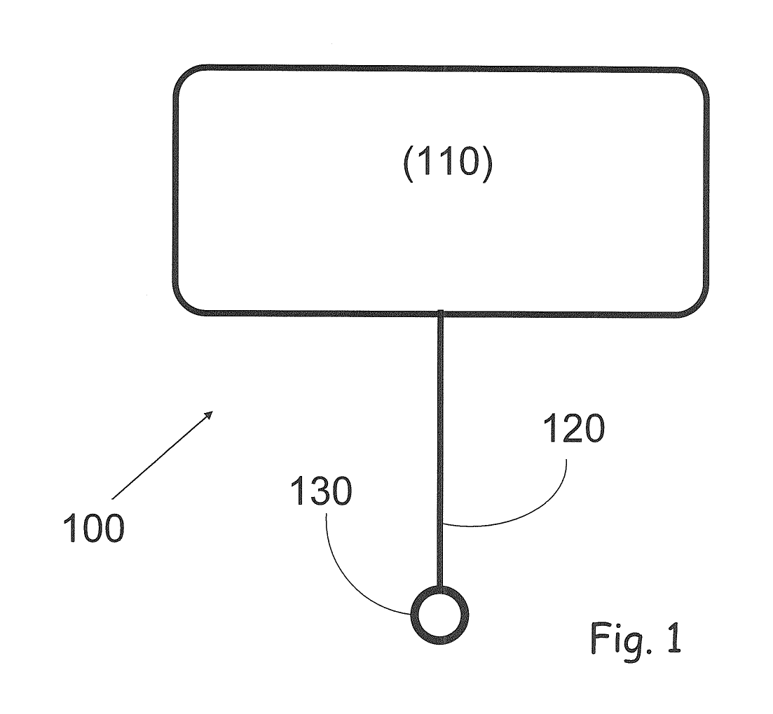

FIG. 1 is a screenshot illustration of a floating, clickable pop-up 100 that can be placed on any visual media and on any screen, constructed according to the principles of the present invention. Pop-up 100 has a content box 110 for text or imagery content. Pop-up 100 also has a connector 120 to connect content box 110 to a described or “speaking” or “thinking” subject (not shown), for example. A snap-end 130 connects connector 120 directly to the subject. The screen can include an “ask” button or any form of visual survey. The method provides for voting or pointing at specific details in visual media, including pictures and video. Voting can be, for example, in an actual election between candidates, or between two or more choices of any kind, such as showing a picture of yourself in two different suits and asking respondents to choose between the two looks.

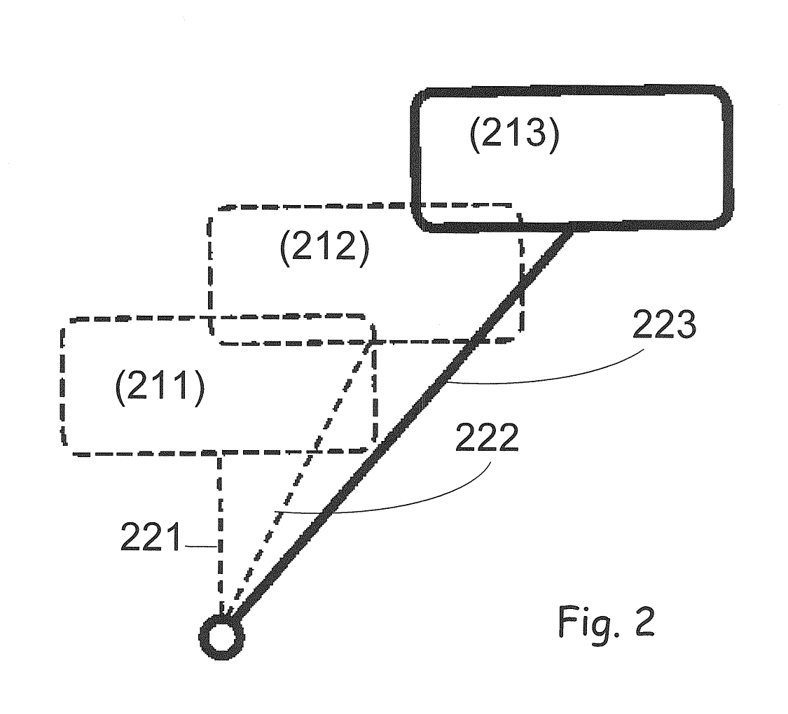

FIG. 2 is a screenshot illustration of the ability to drag and move the floating pop-up of FIG. 1, constructed according to the principles of the present invention. Successive positions of content box 211, 212, 213, as being dragged by a user, is automatically displayed with a correspondingly length and angle adjustment for connector 221, 222, 223.

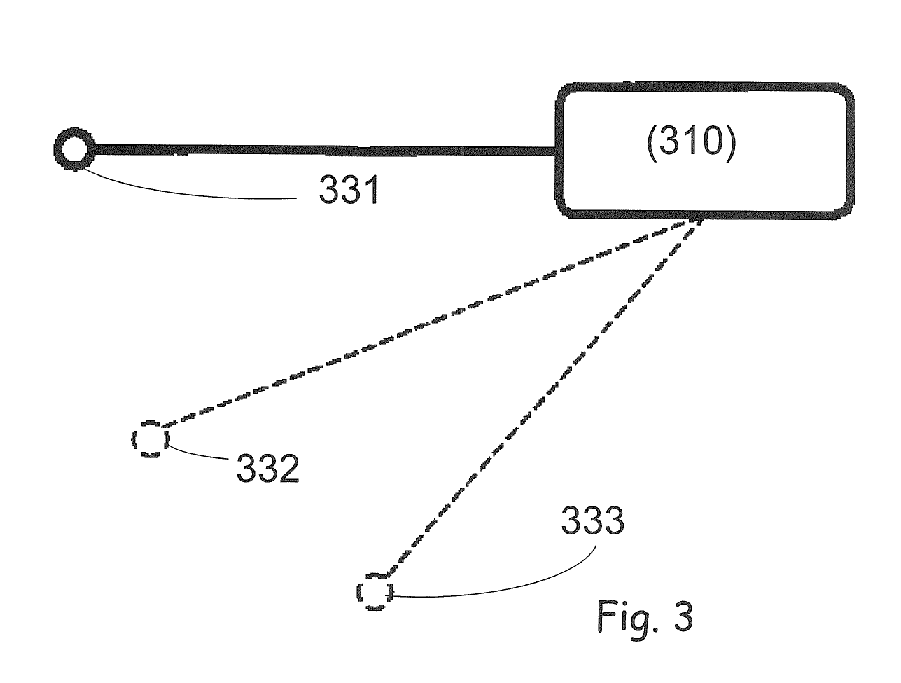

FIG. 3 is a screenshot illustration of the ability of floating pop-up 310 to point anywhere as a dynamic indicator, constructed according to the principles of the present invention. Floating pop-up 310 remains in the same position, while snap-ends 331, 332, 333 are alternatively used to point to different subjects, features of subjects or otherwise different areas of the screen. The dynamic indicator can be stretched to point to anything or anywhere on the visual media surface. This would typically be used in designing a question page for changing the position of a pop-up 310 , for example, relative the position of a picture element.

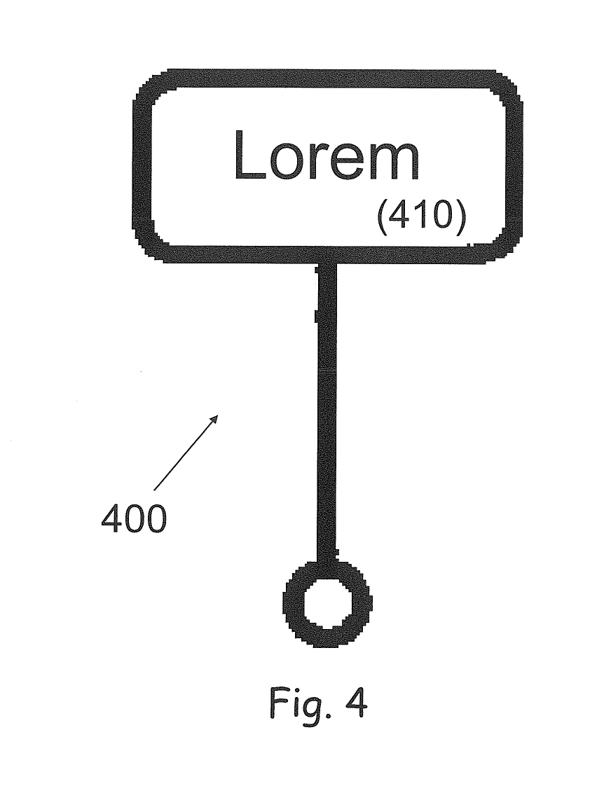

FIG. 4 is a screenshot illustration of the ability to write on the floating pop-up, constructed according to the principles of the present invention. Pop-up 400 has a content box 410 for text. It can contain graphical and/or textual content.

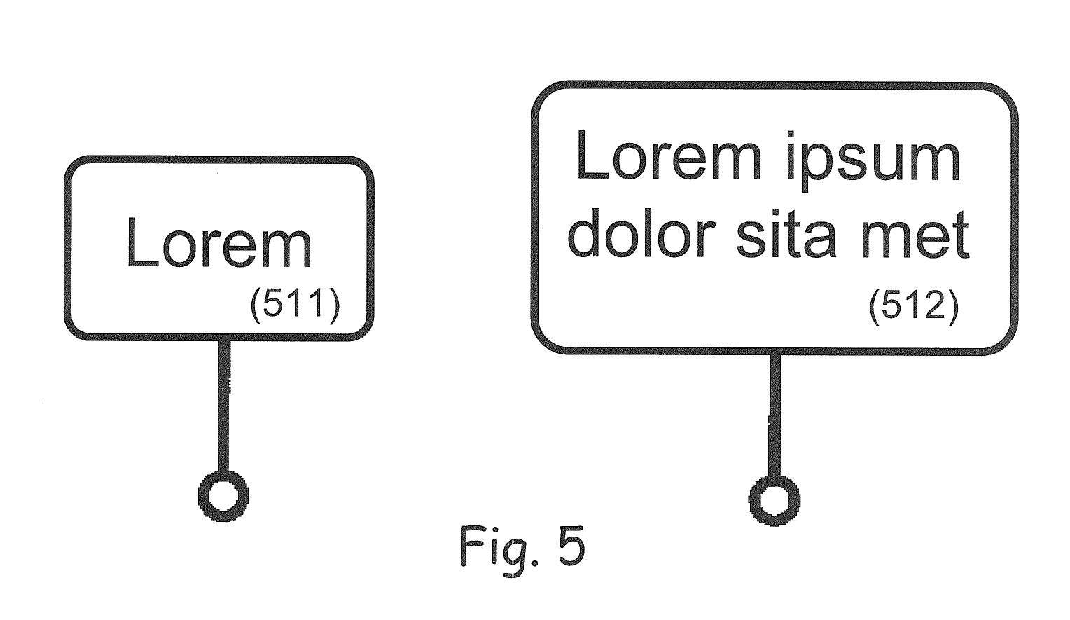

FIG. 5 is a screenshot illustration of the ability of the floating pop-up to automatically adjust its size to the text length, constructed according to the principles of the present invention. Pop-up 511 displays the single word “Lorem.” Pop-up 512 displays the expanded text: “Lorem ipsum dolor sita met.” Therefore the size of pop-up 512 is correspondingly increased.

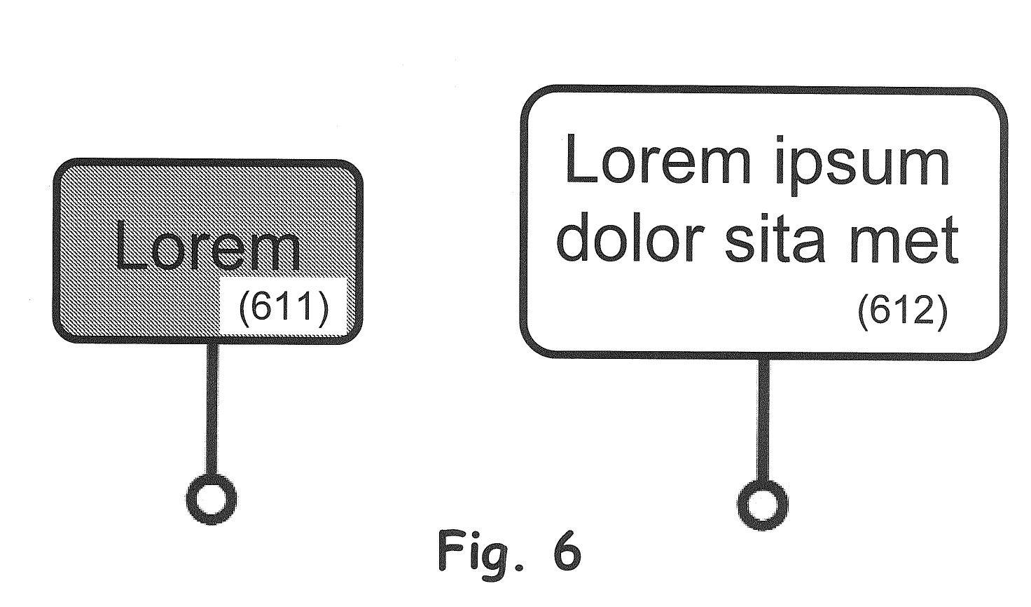

FIG. 6 is a screenshot illustration of the ability to differentiate among a plurality of on-screen floating pop-ups by means of colors, fill patterns and/or fonts, etc, constructed according to the principles of the present invention. Pop-up 611 displays the single word “Lorem” with a fill-pattern. Pop-up 612 displays an expanded text with no fill-pattern, the contrast in fill-pattern usage is provided to enhance the user's ability to more readily differentiate between alternatives. Users can tap or click to choose or vote.

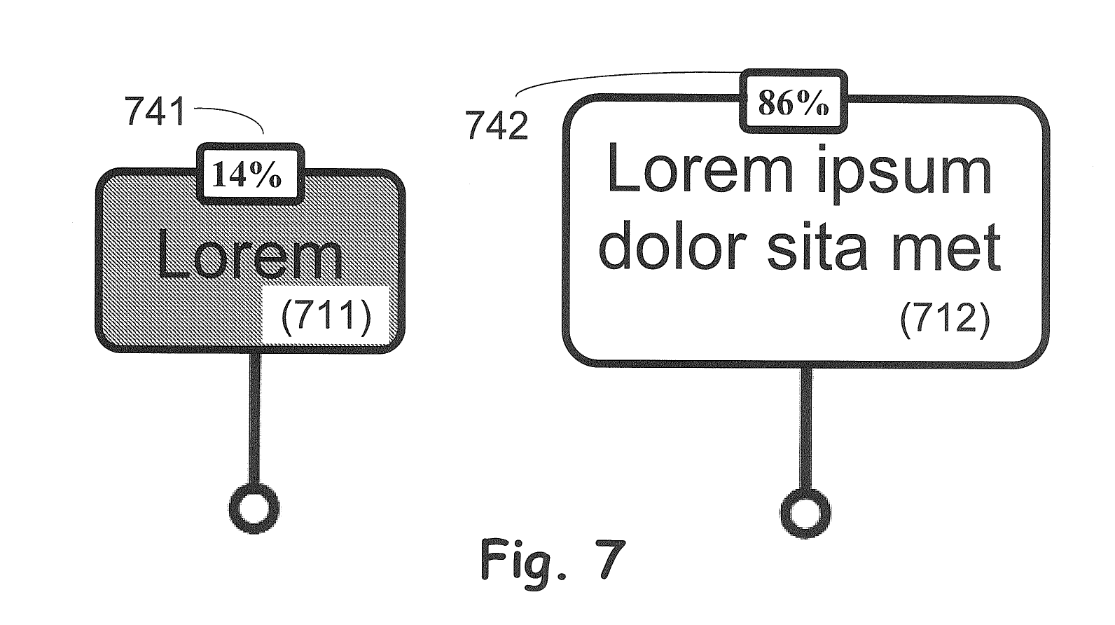

FIG. 7 is a screenshot illustration of the ability to specify the “share of votes” among a plurality of on-screen floating “answer” pop-ups by displaying corresponding answer percentages 741, 742, constructed according to the principles of the present invention.

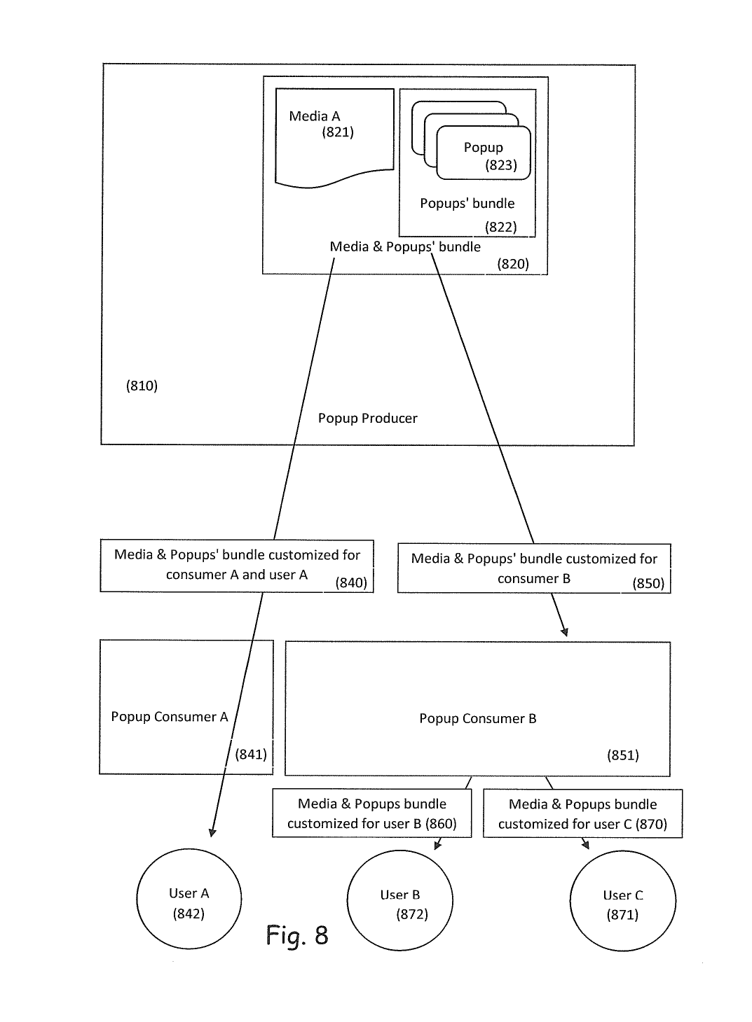

FIG. 8 is a schematic illustration of the relationship between the popup producer 810 and a plurality of consumers 841, 851 and general users 842, 872, 871, constructed according to the principles of the present invention. Popup producer 810 provides a media and popups' bundle 820 for exemplary media A 821 and exemplary popups' bundle 822, including exemplary popup 823. An exemplary media and popups' bundle is customized for consumer A and user A 840 and another exemplary media and popups' bundle is customized for consumer B 850. An exemplary media and pop-ups' bundle is customized for user B 860 by pop-up consumer B and another exemplary media and pop-ups' bundle is customized for user C 870 by pop-up consumer B.

Users can be posers of questions or respondents. Users register for the application, but do not necessarily ask any questions. Consumers are respondents, but are not necessarily registered users. The pop-up is a box with text, a snap-end and the connector between them. The pop-ups bundle includes a question, the asker's username and avatar, if available and at least one, but usually more than one pop-up. The media may include at least one of at least one of photos, cartoons, movies, etc.

The pop-up consumer is typically someone who is browsing the web. He arrives at a web site and sees an question being asked, as described by the present invention.

### Types of Media:

Any visual media and visual display, including, but not exclusively—pictures, videos, screens of any sort, 3D images and motion pictures, holographic representations and any other kind of visual representation. In some embodiments all this resides on hardware such as a smartphone or a PC. The smartphone or PC has a processor executing instructions stored in its storage, and the instructions cause the processor to do what is disclosed. In some embodiments, a combination of the hardware and the instructions form a mechanism for posing a question and a mechanisms for responding thereto. That is, the process is carried out by a judicious combination of hardware and software. Each participant has his own hardware (phone, PC, etc.), so the appropriate software will need to be available to everyone, by download, for example.

### Examples of Use Case Scenario's:

Shopping dilemma of any kind: does an item fit? Should I buy it? Is it a good price? How much would you pay? What to choose—this or that)
   Example: When shopping and wondering if a pair of shoes fit or which pair to choose.
Political Questions
example: should the education budget be cut more than the health budget or the other way around
Life Style Related Questions
   (what to read, should I read, what to read first, and on the same line of thought, what to go see, what should I listen to/should I go see, what should I go listen to, what to see, listen to first—could relate to music, the cinema, art gallery, clubs, concerts or any social/cultural event.
   Used also for asking people for their opinions on what to choose between several options or asking people what they think about other people, someone's new boyfriend for example. (vote! Do you love him, hate him, think he's ok, think she could do better, etc . . . )
Sport Related Questions.
   From asking questions related to game results to questions on any related statistics.
   Example: “think soccer team A will beat soccer team B tonight?” Or “how do you think tonight's playoff will end? 2:0 or 0:2 or 0:0
   Or “what will be the average score during this NBA season? Etc
Food and drink related questions:
   what to choose, what you think, how much would you pay, etc
Any scenario in which responsive systems ask users questions on their own
   Smart houses that ask you “did you leave the TV on, on purpose” for example or google glasses that alert you to a 50% off sale at a near by store and ask if you want to go in or for directions how to get there or see the items on sale, etc.
Overlaid on Content Displayed on Other Sites, App, Mobile or Other Devices Displaying Graphic Imagery and Information
Google glasses and smart-phones for example:
   YouTube for example—popping up to relate and engage with a specific detail, for example pointing to an actress or model pair of jeans and using a pop-up to ask if they like them.
   The pop-up will popup at determined points in the time line and will pop out at determined points in the time line.
   Items displayed in commercial sites or life style blogs/sites.
   Visual sharing platforms and social platforms such as instagram™, Pinterest™, etc are used.
   The popup of the present invention can adjust itself to various media, for example:
   1) adjust the look and feel of the popup according to the consuming device characteristics for example (not limited to) screen resolution, screen size, orientation, etc
   2) adjust the look and feel of the popup over time (in time relevant media such as video) for example (but not limited to) a popup that follows an object over time in a film.
   3) adjusting the look and feel of the popup according to a user profile, for example (but not limited to) a popup can adjust its characteristics to a user profile so that if user A likes the color blue and user B likes the color red the system may utilize user profiling and user preference to adjust the popup's characteristics

Having described the present invention with regard to certain specific embodiments thereof, it is to be understood that the description is not meant as a limitation, since further modifications will now suggest themselves to those skilled in the art, and it is intended to cover such modifications as fall within the scope of the appended claims.

We claim:

1. A method of facilitating expression and interaction between users, the users including a plurality of posers of at least one question and a plurality of respondents, the method comprising:
receiving from a poser a posed question having at least two outcomes ;
displaying the posed question on hardware; and
receiving a response from a portion of the plurality of respondents, the response being a form of at least one of:
voting;
pointing at; and
choosing between specific options in media content, the content comprising at least one of:
text;
audio;
photo(s);
drawing(s);
3D image(s);
motion picture(s);
holographic representation(s);
cartoon illustration(s); and
video element(s).

2. The method of claim 1, wherein the media content are visually presented.

3. The method of claim 1, wherein the media content are audibly presented.

4. The method of claim 1, wherein the respondents are encouraged to respond based on relevance determined by prior responses, based on a statistical history compiled for the respondents, as related to their demographics and other profile characteristics.

5. The method of claim 2, wherein the visually presented media content comprises at least one floating, clickable pop-up.

6. The method of claim 5, wherein the at least one floating, clickable pop-up comprises at least a content box for text or imagery content.

7. The method of claim 6, wherein the at least one floating, clickable pop-up comprises at least a connector to connect the content box to a described or “speaking” or “thinking” subject.

8. The method of claim 6, wherein the at least one floating, clickable pop-up comprises at least one snap-end connecting the connector directly to the subject.

9. The method of claim 7, wherein the at least one floating, clickable pop-up screen further comprises visual survey mechanisms.

10. The method of claim 9, wherein the visual survey mechanisms further comprise an “ask” button.

11. The method of claim 8, further comprising enabling a user to point to the at least one floating pop-up anywhere as a dynamic indicator, wherein the at least one floating pop-up remains in the same position, while the at least one snap-end is alternatively used to point to different subjects, features of subjects or otherwise different areas of the screen.

12. The method of claim 10, further comprising enabling a user to write on the at least one floating pop-up.

13. The method of claim 10, further comprising displaying the outcomes among a plurality of on-screen floating “answer” pop-ups by displaying corresponding answer percentages.

14. The method of claim 10, wherein the at least one pop is configured to popup at a pre-determined point in the time line and pop out at a pre-determined point in the time line.

15. A application running on hardware, the application facilitating expression and interaction between users, the users including a plurality of posers of questions and a plurality of respondents, the application comprising:
a mechanism for posing a question having at least two outcomes by a user when acting as one of the plurality of posers;
a mechanisms for responding by a user acting as one of the plurality of respondents by at least one of:
voting;
pointing at; and
choosing between specific options in media content, the content comprising at least one of:
text;
audio;
photo(s);
drawing(s);
3D image(s);
motion picture(s);
holographic representation(s);
cartoon illustration(s); and
video element(s).

17. The system of claim 16, wherein the hardware includes a smartphone or PC having a processor for executing instructions stored in its storage, and wherein the mechanism for posing the questions and the mechanism for responding thereto are formed by the combination of the hardware and the instructions.

18. The system of claim 16, further comprising a web site for coordination of activities between the system and the users.
